(19) United States
(12) Patent Application Publication
(10) Pub. No.: US 2005/0175264 A1
(43) Pub. Date: Aug. 11, 2005

(54) Segmented ball/roller guide for a linear motion bearing

(76) Inventors: Erick Kim, Flushing, NY (US); Alison Ng, New York, NY (US)

Correspondence Address: DILWORTH & BARRESE, LLP, 333 EARLE OVINGTON BLVD., UNIONDALE, NY, 11553, US

(21) Appl. No.: 10/505,923

(22) PCT Filed: Feb. 27, 2003
(86) PCT No.: PCT/US03/05653

Related U.S. Application Data
(60) Provisional application No. 60/360,155, filed on Feb. 27, 2002.

(51) Int. Cl. F16C 19/00

(52) U.S. Cl. 384/51

(57) ABSTRACT

A guide (10) associated with a linear motion and screw system is configured to at least partially surround one of a plurality of rolling elements (20) so as to prevent ball-to-ball contact between the one rolling element and adjacent rolling elements during displacement of the rolling element along a circulation ball track.

### CROSS-REFERENCE TO RELATED APLICATION

This application is based on U.S. Provisional Application No. 60/360,155 filed on Feb. 27, 2002 and fully incorporated herein by reference.

### BACKGROUND OF THE INVENTION

1. Field of the Invention

The present invention relates generally to anti-friction linear motion bearing assemblies. More particularly, the present invention is directed to a segmented ball/roller guide assembly utilized to eliminate vibrations caused by ball-to-ball contact in linear motion bearings.

2. Description of the Related Art

Linear bearings or ball screws are well known for their significant reduction in dynamic and static friction versus plain bearings or lead screws under load. There are different types of linear bearings and ball screws offered on the market today. However, they share a common focus to control ball recirculation properly to provide smooth linear or rotary motion.

Typical linear rolling bearing assemblies include a series of rolling elements moving about a circulation path which circulation path is formed in the periphery of a track member and a surrounding and enclosing bearing cover confining the rolling elements in their recirculation path. In order to achieve an accurate linear motion, the axis of the bearing assembly must be precisely aligned with the desired direction of motion along the supported structure. In addition this precise alignment also minimizes skewing forces acting on the bearing assembly, which skewing forces tend to reduce the load/life performance of the bearing assembly.

Installation of such bearing assemblies on a supporting structure (i.e., shaft, splined shaft, guideway or rail) typically involves precision machining of locating surfaces in order to properly align the bearing assembly on the supporting structure. Such bearing assemblies are typically installed in sets, each comprised of a number of variously facing bearings such as to engage a series of surfaces on the supporting structure (i.e., such as above and below a supporting surface and/or along a lateral edge of a supporting surface). In such instances it is usual to provide a bearing adjustment for enabling precision adjustment of the bearing assembly on the supported structure and also for establishing a proper bearing pre-load by adjusting an opposing bearing assembly for reasons well known to those skilled in the art. In such installations, considerable precision machining of the supported structure is necessitated which is difficult and expensive to accomplish on the supporting structures.

Many of the disadvantages discussed were overcome in a linear motion bearing structure disclosed, among others, in U.S. Pat. Nos. 5,346,313; 5,558,442; 5,613,780 issued to Alison Ng and commonly owned by Thomson Industries, Inc., and fully incorporated in this application by reference. The above-identified patents, and particularly the U.S. Pat. No. 5,613,780, disclose a linear motion bearing assembly comprising a plurality of ball retainer segments including at least one ball track having a load bearing portion, a return portion and a turnaround portion. A plurality of individual balls is then disposed in the ball track to enable the linear bearing to provide low friction motion.

Such low friction is particularly advantageous in structures related to biased linear motion bearing assemblies of the type, which support a carriage or a pillow block for linear movement along an elongated splined shaft. These bearing assemblies can either be of the open type or the closed type.

Typically, in the linear bearing assemblies, as disclosed in the above-identified patents, the ball-to-ball contact in the ball track generates adverse conditions when the bearing is in operation. The ball-to-ball contact generates mechanical and/or acoustic vibrations. Radial bearing industries created ball cage technology to eliminate vibration due to ball-to-ball contact. However, recent developments in linear bearing technologies are working toward elimination of the ball-to-ball contact itself.

One such development is a rolling element chain, also known as a ball chain. Rolling element chains are designed to contain a row of rolling elements, i.e., a ball, as one subassembly with separators between the rolling elements to avoid ball-to-ball contact. An example of one such rolling element chain is disclosed in U.S. Pat. No. 5,947,605 to Shirai. The rolling element chain is made usually from very flexible material to allow ball recirculation. Additionally, careful material selection improves the vibration dampening characteristics of the ball chain.

As much as it is beneficial to the reduction of noise or vibration, the rolling element chain also has its drawbacks. The rolling element chain does not provide designers with much freedom in designing ball track geometry. Due to the single chain mechanism, rolling elements must follow a track geometry that is normal or nearly normal to the direction of an applied load on the ball track. This restricts the location of the return track geometry for the ball track and often results in an unwanted outside bearing envelope dimension increase or modification due to the location of return geometry for the rolling elements. If the bearing requires a very strict return geometry away from the direction normal to the applied load on the ball track, the rolling element chain must be made from very flexible material to allow more twist. However, this is a very undesirable design due to long term effects on the material when it is twisted constantly.

Another development towards the elimination of ball-to-ball contact in linear motion and ball screw systems is a ball spacer. Ball spacers are individual pieces of a material, such as a resin or polymer, which separate rolling elements in a bearing or ball screw. Ball spacers allow elimination of ball-to-ball contact without the restrictions provided by the rolling element chain. Individual ball spacers do not have connections between them like the rolling element chain and allow designers to implement ball-to-ball separators without major change in ball track geometry.

Although ball spacers allow more freedom in designing ball return geometry, they do have disadvantages. Due to the use of individual spacers, designers must ensure the spacers will not fall out of its position during operation. If the spacers are dropped out of its position between the balls to the bottom or sides of the ball track, they will create severe impediments to linear motion. This could result in a catastrophic failure on the bearings.

U.S. Pat. No. 6,352,367 illustrates the above-discussed drawback by disclosing a spacer located between adjacent rolling elements and configured so that if the distance between the balls exceeds the outer dimension of the spacer, it can be easily displaced off a ball track, which leads to the consequences discussed above.

### SUMMARY OF THE INVENTION

Accordingly, it is an objective of the present invention to provide a new ball-to-ball separator technology, which will eliminate the disadvantages of the prior art rolling element chains and ball spacers.

It is another object of the present invention to provide a segmented ball/roller guide for eliminating ball-to-ball contact in linear motion bearings.

It is a further object of the present invention to provide a segmented ball/roller guide for reducing mechanical and/or acoustic vibrations in linear motion bearings.

It is yet another object of the present invention to provide a segmented ball/roller guide which allows greater flexibility in designing return track geometry.

The inventive ball/roller guide assembly has a guide configured to support and guide at least one rolling element so that, even if a distance between adjacent rolling elements displaceable along a ball track becomes large enough for the guide to drop off the track, it remains on the track. Accordingly, since the guide is prevented from unacceptable displacement that, otherwise, could result in impediments to the linear motion, it maintains the desired alignment between adjacent rolling elements along the ball track eliminating.

The segmented ball/roller guide of the present invention includes a first spacer member, a second spacer member and at least one connection member for connecting and supporting the first and second spacer at an equal diametrical distance around a ball bearing. The first and second spacer members are formed generally in a disc-like shape and may be formed with at least one concave surface so when assembled the ball bearing will be rotatably held within the segmented ball/roller guide. Preferably, the guide is dimensioned to maintain a substantially continuous sliding contact with the thus supported ball baring. In use, the ball bearing will circulate on a ball track of a linear motion bearing with the spacers preventing ball-to-ball contact. Since each segmented ball/roller guide includes two spacer members, only one segmented ball/roller guide is required for every other ball of a plurality of balls placed on the ball track of a linear motion bearing. Additionally, the connection member acts as a guide for the ball when circulating around the ball track.

### BRIEF DESCRIPTION OF THE DRAWINGS

The above and other objects, features, and advantages of the present invention will become more apparent in light of the following detailed description of exemplary embodiments thereof taken in conjunction with the attached drawings in which:

FIG. 1 is a perspective view of a first embodiment of a segmented ball guide assembly in accordance with the present invention;

FIG. 2 is a plan front view of the first embodiment of a segmented ball guide assembly in accordance with the present invention;

FIG. 3 is a perspective view of the segmented ball guide of FIG. 1 with the ball removed;

FIG. 4 is a perspective view of the support/guide structure of the segmental ball guide sown in FIG. 1 in accordance with the present invention;

FIG. 4A is a cross-sectional view taken along lines I-I in FIG. 4;

FIG. 5 is a perspective view of another embodiment of a support/guide structure of a segmented ball guide in accordance with the present invention;

FIG. 6 is a perspective view of still another embodiment of a support/guide structure of a segmented ball guide in accordance with the present invention;

FIG. 7 illustrates a plurality of segmented ball guide assemblies located in a load bearing portion of a ball track of a linear bearing assembly;

FIG. 8 is an enlarged view of FIG. 7; and

FIG. 9 is a perspective view of a still another embodiment of a segmented ball guide in accordance with the present invention.

### DETAILED DESCRIPTION OF THE PREFERRED EMBODIMENTS

Preferred embodiments of the present invention will be described hereinbelow with reference to the accompanying drawings. In the following description, well-known functions or constructions are not described in detail to avoid obscuring the invention in unnecessary detail. It is provided that identical elements are structurally and functionally equivalent throughout the drawings.

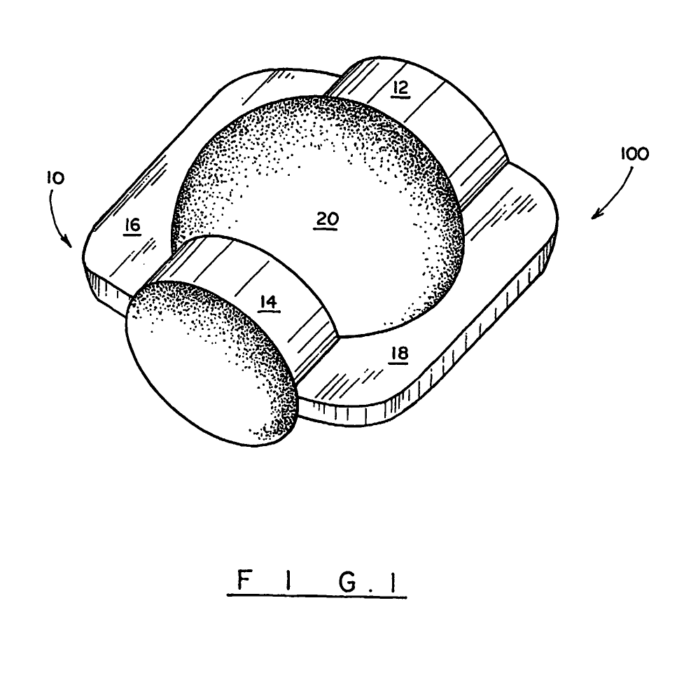

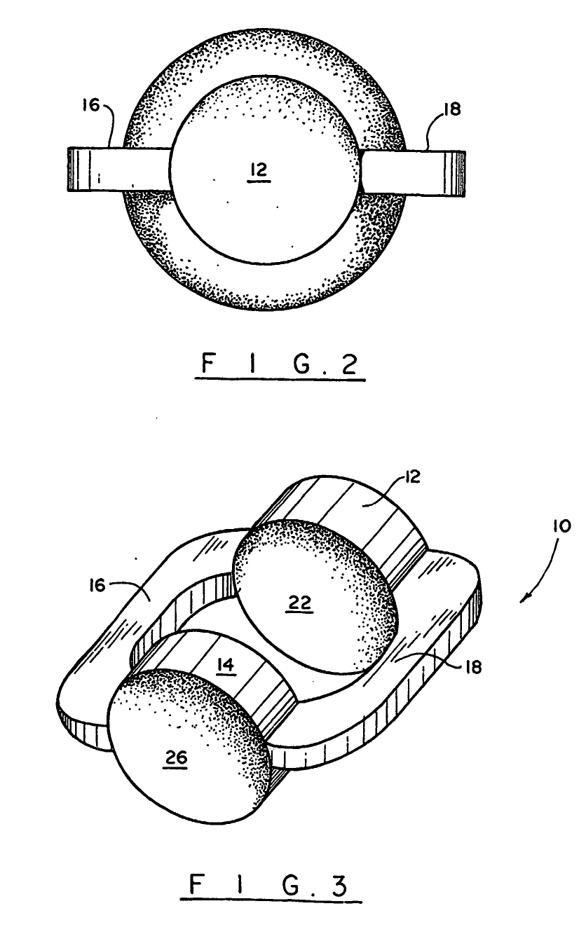

Referring to the FIGS. 1-8, a segmented ball/roller guide in accordance with the present invention is identified generally by the reference numeral 10.

FIGS. 1-5 illustrates a segmented ball/roller guide assembly 100 with a ball bearing contained therein. The segmented ball/roller guide 10 of the present invention includes at least one first spacer member 12. While the first spacer member 12 can completely or partially surround a rolling element, such as a ball bearing 20, as will be discussed hereinbelow, many of the inventive modifications of the support/guide 10 include a second spacer 14. The spacers 12 and 14 are spaced from one another along a travel direction and function as a guard preventing contact between adjacent ball bearings 20 travelling along a track. The distance between the spacers 12 and 14 may be selected so that it is at least slightly greater than the outer diameter of the ball bearing 20. As a result, at least the trailing portion of the guide 10 maintains a substantially continuous sliding contact with the ball bearing 20 without detrimentally affecting the rotation of the ball bearing. Preferably, as a result of the geometry of the spacers 12, 14 and the ball bearing 20, the former are spaced at a uniform radial distance around the ball bearing 20 and are juxtaposed with its leading 23 and trailing 21 segments or regions, respectively. To maintain such a uniform distance, the inventive assembly includes at least one first connection member 16 (FIG. 5), but, preferably, two connection members 16 and 18, as better illustrated in FIGS. 1-4.

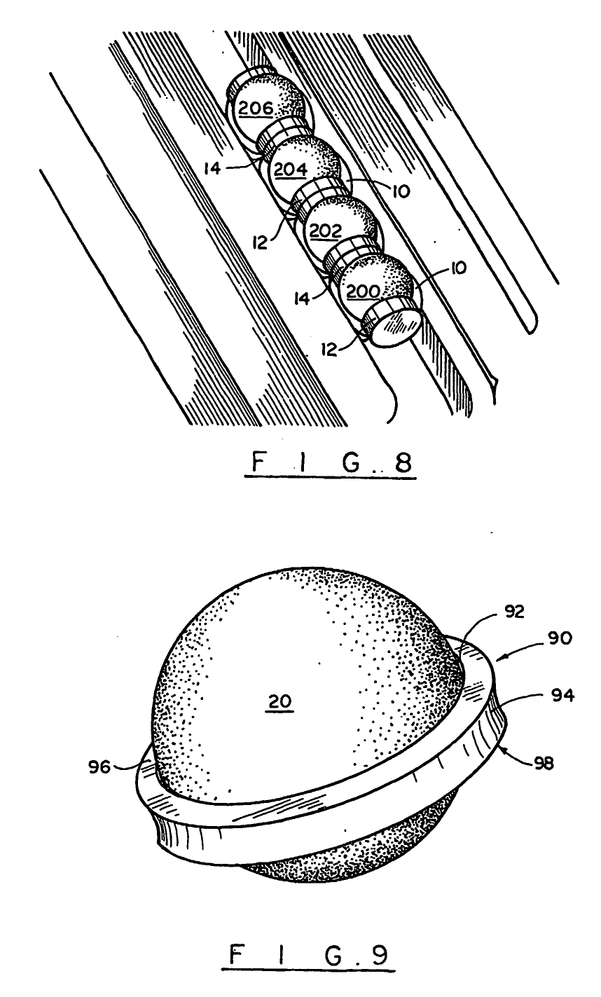

To reliably guide the ball bearing 20, the first and second spacer members 12, 14 may be formed with seats each having a respective concave surface 22, 24 (see FIG. 3) extending complementary to the regions 21, 23 of the ball bearings 20. Accordingly, when assembled, the ball bearings 20 will be rotatably held within the segmented guide 10 and, even if a distance between adjacent ball bearings 200-206 (FIG. 8) is unacceptably increased, the guide 10 remains in sliding contact with the guided ball baring. In practical terms, the guide 10 cannot be displaced from its position between adjacent ball bearings running along a circulation passage of a ball track formed in a bearing carriage regardless of their relative position along the ball track. Preferably, the spacer members 12, 14 will have concave surfaces formed on both sides 24, 26 one to retain the ball 20 and one for contact with an adjacent ball when in motion, the operation of which will be described below. Alternatively, however, the inner surfaces 22, 24 can be flat or even convex to still provide contact with the leading 23 and trailing 21 regions of the ball bearing 20.

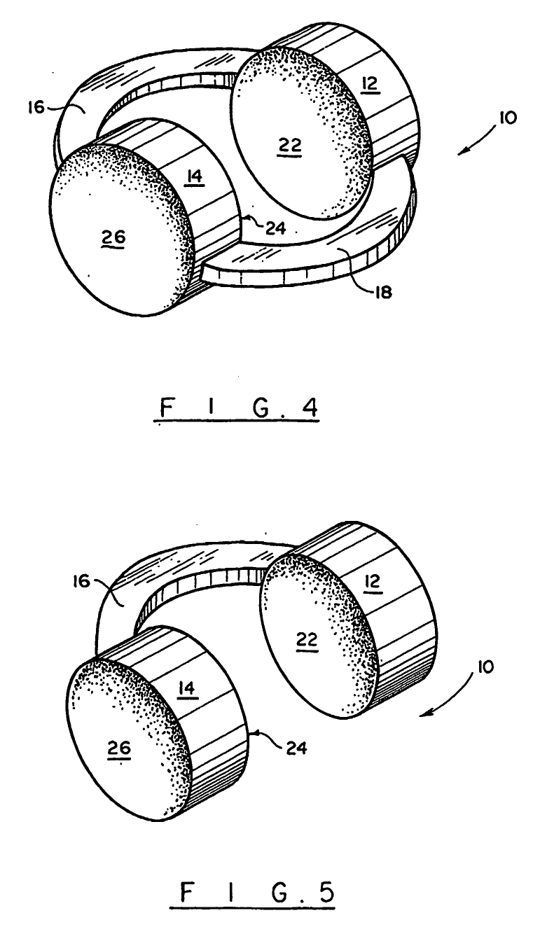

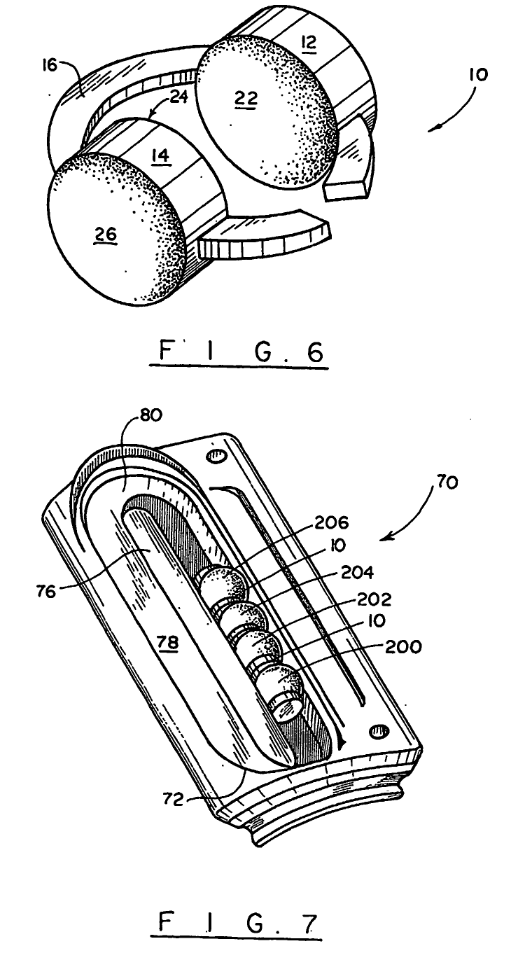

FIGS. 4 through 6 illustrate various embodiments of the segmented ball/roller guide. Fundamentally, the variations in the different embodiments are in the number and structure of the connection members. As shown in FIG. 5, the ball/roller guide 10 includes only one connection member 16, whereas the embodiment shown in FIG. 6, has one of the connection members recessed. The geometry and particular structure of the connection members 16, 18 depend the particular design of the ball track. Advantageously, bottoms 17 and 19 of the connection elements 16, 18 are narrowed to have an arcuate or substantially conical shape (FIG. 4A), which will reduce a contact area and, consequently, frictional forces between the connection elements and side surfaces of the ball track. Operationally, the embodiments shown in FIGS. 4 through 6 are functionally similar. The spacers 12, 14 as well as connection elements 16 and 18 can be detachably coupled to one another by various fasteners. In addition, the guide can be configured to have all of the components machined with surfaces extending complementary to and matching one another during the assembly of the guide 10. For example, the spacers 12, 14 each can have recesses receiving complementary formed projections of the connection elements 16, 18. Alternatively, the components of the ball/roller guide can be made integrally or unitarily from a variety of materials including engineering polymers and thermoplastics characterized by a low-friction coefficient.

In use, the segmented ball/roller guide will circulate on a ball track of a linear motion bearing with the spacer members preventing ball-to-ball contact. FIGS. 7 and 8 show a ball retainer segment or bearing carriage 72 of a linear bearing assembly 70. The ball retainer segment 72 includes a ball track 74 having a load bearing portion 76, a return portion 78 and a turnaround portion 80. Since each segmented ball/roller guide 10 includes two spacer members 12 and 14, only one segmented ball/roller guide 10 is required for every other ball of a plurality of balls placed on the ball track 74 of linear bearing 70. Spacer members 12 and 14 will retain a first ball 200 and a second ball 202 will circulate in the outer concave surface 26 of spacer member 14 and an outer concave surface (not shown) of spacer member 12 of the next adjacent guide 10. As the balls 200, 202, 204, 206 circulate to provide linear motion the spacer member 12, 14 will eliminate ball-to-ball contact. Additionally, the connection member or members 16, 18 act as a guide for the balls 20 when circulating around the ball track 74 while preventing the displacement of the balls off the track.

FIG. 9 illustrates a fifth embodiment of the segmented ball guide. As shown in FIG. 9, the guide 90 is formed as an annular member having an inner surface 92, an outer surface 94, a top surface 96 and a bottom surface 98. The guide is preferably formed with flat surfaces. As a modification to the annular member, the inner surface 92 and outer surface 94 may be formed in a concave shape to minimize the spacing between balls 20. As with the other embodiments described above, the annular member 90 will act as a guide for the balls when circulating around the ball track.

The present invention allows the benefits of both the rolling element chain and ball spacers to be used without the associated disadvantages. The segmented ball/roller guide of the present invention acts in very much the same manner as the rolling element chain without the disadvantage of limited twist. By not having the individual segmented ball guide assemblies connected to each other, an infinite amount of twist between the ball guides is possible resulting in a great amount of flexibility in designing the return track geometry.

Furthermore, the segmented ball/roller guide is not in danger of falling out of position when the gap between rolling elements, i.e. bearing balls, increases over time as occurs with ball spacers. This is achieved by the connection member or members 16, 18 between the ball spacer members. This allows designers of linear bearings to ease the tolerance requirements in ball track geometry. This also allows designers freedom to choose either hard or soft material for the segmented ball/roller guide since changes in the gap distance between balls will not result in catastrophic failure.

While the present invention has been described in detail with reference to the preferred embodiments, they represent mere exemplary applications. For example, the ball bearing 20 can be incorporated in radial bearings. Outer surface 85 (FIG. 9) of at least one of the spacers 12, 14 can be recessed along the trailing or leading regions 23, 21 of the rolling element 20 so that a shape and size of recess allows an adjacent ball bearing to be guided and supported. Thus, it is to be clearly understood that many variations can be made by anyone having ordinary skill in the art while staying within the spirit and scope of the present invention.

1. A guide assembly for at least one rolling element displaceable along a path, comprising a guide configured to guide the at least one rolling element along the path while maintaining a substantially continuous sliding contact therewith along the path.

2. The guide assembly of claim 1, wherein the guide includes at least one spacer extending between diametrically opposite leading and trailing regions of the at least one rolling element.

3. The guide assembly of claim 2, wherein the at least one spacer is endless.

4. The guide assembly of claim 2, wherein the at least one spacer is discontinuous along one of the leading and trailing regions of the at least one rolling element.

5. The guide assembly of claim 2, wherein the at least one spacer has opposite inner and outer sides extending either parallel to one another or converging toward the bottom so as to reduce a contact surface of the bottom.

6. The guide assembly of claim 5, wherein the bottom has an arcuate or substantially conical.

7. The guide assembly of claim 5, wherein the inner side of the at least one spacer has at least one portion juxtaposed with a respective one of the leading and trailing regions of the rolling element and being curved to maintain the substantially continuous contact with the respective one of the leading and trailing regions.

8. The guide assembly of claim 7, wherein the curved portion of the spacer has a surface extending complementary to the respective one of the leading and trailing regions of the at least one rolling element.

9. The guide assembly of claim 5, wherein the outer side of the at least one spacer has a region provided with a curved surface configured to slidingly support a second rolling element located immediately upstream or downstream from the at least one rolling element.

10. The guide assembly of claim 2, wherein the guide further comprises:
a second spacer juxtaposed with a respective one of the leading and trailing regions of the at least one rolling element, the second spacer being configured to maintain the substantially continuous contact with the at least one rolling element, and
at least one connector extending between and coupling the at least one and second spacers to ensure the substantially continuous contact between the at least one rolling element and the second spacer during the displacement of the at least one rolling element along the path.

11. The guide assembly of claim 10, wherein the guide further comprising a second connector spaced from the at least one connector and extending between the at least one and second spacers, so as the at least one rolling element is surrounded by the guide.

12. The guide assembly of claim 11, wherein one of the at least one and second connectors is discontinuous.

13. The guide assembly of claim 11, wherein the at least one and second connectors and the at least one and second spacers are detachably assembled or unitarily formed.

14. The guide assembly of claim 11, wherein the guide is made from materials selected from the group consisting of polymers, thermoplastics and a combination of polymers and thermoplastics and characterized by a low-friction coefficient.

15. A linear motion and ball screw system comprising:
an endless circulation passage;
a plurality of rolling elements displaceable in the endless circulation passage along a travel direction; and
at least one guide receiving the plurality of rolling elements and configured to prevent ball-to-ball contact between the one rolling element and upstream and downstream rolling elements which are located adjacent to the one rolling element.

16. The linear motion and ball screw system of claim 15, wherein the at least one guide comprises:
a leading spacer located between the at least one rolling element and the downstream rolling element and spanning the circulation passage;
a trailing spacer located between the at least one rolling element and the upstream rolling element and spanning the circulation passage; and
at least one connector extending between and connected to the leading and trailing spacers and extending laterally beyond the circulation passage to at least partially enclose the at least one rolling element.

17. The linear motion and ball screw system of claim 16, further comprising a second connector spaced diametrically from the at least one connector and extending between the leading and trailing spacers and laterally beyond the circulation passage.

18. The linear motion and ball screw system of claim 17, wherein at least one of the one and second connectors is discontinuous to reduce friction between the connectors and a surface adjacent to the circulation passage.

19. The linear motion and ball screw system of claim 16, wherein at least one of the leading and trailing spacers has opposite inner and outer surfaces curved inwards toward one another to form a first seat for the at least one rolling element and a respective one of the upstream and downstream rolling elements.

20. The linear motion and ball screw system of claim 16, wherein the guide is configured to have the leading and trailing spacers spaced uniformly from a rolling axis of the at least one rolling element.

21. The linear motion and ball screw system of claim 16, wherein the at least one rolling element and at least the trailing spacers are in substantially continuous contact during displacement of the at least one rolling element long the circulation passage.

22. The linear motion and ball screw system of claim 17, wherein the leading and trailing spacers and the one and second connectors are detachably connected to one another or fixed to one another.

23. A linear motion bearing comprising:
a bearing carriage provided with at least one endless circulation passage;
a series of individual bearing balls movable along the circulation passage; and
a plurality of guides slidable along the circulation ball passage and arranged to have every other bearing ball guidingly supported in a respective guide and to prevent adjacent bearing balls from ball-to-ball contact during displacement of the bearing balls.

24. The linear motion bearing of claim 23, wherein the plurality of guides each comprises:
a leading spacer spanning the circulation passage;
a trailing spacer located upstream from the leading spacer and spanning the circulation passage; and
at least one connector extending between and connected to the leading and trailing spacers and extending laterally beyond the circulation passage, whereas, as the series of bearing balls moves along the circulation passage, the guides and the bearing balls are in substantially continuous contact.

25. The linear motion bearing of claim 24, further comprising a second connector spaced diametrically from the at least one connector.
